(19) United States
(12) Patent Application Publication
(10) Pub. No.: US 2023/0063778 A1
(43) Pub. Date: Mar. 2, 2023

(54) ALPHA-BETA TI ALLOY WITH IMPROVED HIGH TEMPERATURE PROPERTIES

(71) Applicant: Titanium Metals Corporation, Henderson, NV (US)

(72) Inventor: John C. FANNING, Henderson, NV (US)

(73) Assignee: Titanium Metals Corporation, Henderson, NV (US)

(21) Appl. No.: 17/894,761

(22) Filed: Aug. 24, 2022

Related U.S. Application Data
(60) Provisional application No. 63/236,363, filed on Aug. 24, 2021.

(51) Int. Cl. C22F 1/18; C22C 14/00

(52) U.S. Cl. CPC C22F 1/183; C22C 14/00

(57) ABSTRACT

An alpha-beta titanium alloy and method of manufacture includes forming an alpha-beta product from a titanium alloy with a composition in weight percent (wt. %) including 5.7-7.5 wt. % Al, 0.8-4.2 wt. % Mo, 0.0-3.0 wt. % Nb, 0.1-3.5 Sn, 0.1-3.0 wt. % Zr, 0.1-0.35 wt. % Si, 0.05-0.25 wt. % O, with the remainder being Ti and incidental impurities, and then heat treating the alpha-beta product with a first heat treatment step including a first temperature and a first time, a second heat treatment step including a second temperature and a second time, and a third heat treatment step including a third temperature less than the second temperature and a third time greater than the second time.

### CROSS-REFERENCE TO RELATED APPLICATIONS

This application claims priority to and the benefit of U.S. Provisional Patent Application No. 63/236,363, filed on Aug. 24, 2021. The disclosure of the above application is incorporated herein by reference.

### FIELD

The present disclosure relates to titanium alloys and particularly to alpha-beta titanium alloys.

### BACKGROUND

The statements in this section merely provide background information related to the present disclosure and may not constitute prior art.

Titanium alloys are commonly used in civil and military aerospace systems. For example, the Ti-6Al-4V and Ti6242 alloys can provide attractive combinations of elevated temperature properties and low density when compared to steels, nickel-base alloys, and aluminum alloys, among others.

One area of particular interest for such alloys, and for alloys with enhanced properties, is flat rolled products (sheet and plate) for use in aeroengine exhaust systems, inner walls, heat exchangers, and heat shields. Another area of emerging interest would be for parts produced by additive manufacturing.

The present disclosure addresses issues related to titanium alloys for use at elevated temperatures among other issues related to titanium alloys.

### SUMMARY

This section provides a general summary of the disclosure and is not a comprehensive disclosure of its full scope or all of its features.

In one form of the present disclosure, a method of manufacturing an alpha-beta titanium alloy includes forming an alpha-beta product from a titanium alloy with a composition in weight percent (wt. %) comprising 5.7-7.5 wt. % Al, 0.8-4.2 wt. % Mo, 0.0-3.0 wt. % Nb, 0.1-3.5 Sn, 0.1-3.0 wt. % Zr, 0.1-0.35 wt. % Si, 0.05-0.25 wt. % O, with the remainder being Ti and incidental impurities, and then heat treating the alpha-beta product with a first heat treatment step comprising a first temperature and a first time, a second heat treatment step comprising a second temperature and a second time, and a third heat treatment step comprising a third temperature less than the second temperature and a third time greater than the second time.

In some variations, the first temperature is between 1600° F. (871.1° C.) and 2000° F. (1093° C.) and the first time is between 15 minutes and 120 minutes. In at least one variation, the second temperature is between 1400° F. (760° C.) and 1900° F. (1037.8° C.) and the second time is between 5 minutes and 90 minutes, and the third temperature is between 1050° F. (565.6° C.) and 1250° F. (676.7° C.) and the third time is between 5 hours and 7 hours.

In some variations, the heat treated alpha-beta product comprises an acicular microstructure. For example, the acicular microstructure comprises needles of an alpha phase in a matrix of a beta phase.

In at least one variation, a time to 0.25% strain at 35 ksi and 950° F. (510° C.) for the heat treated alpha-beta product is greater than 50 hours, for example greater than 75 hours, or greater than 100 hours.

In some variations, the heat treated alpha-beta product has an EN 6072 testing fatigue life of more than 1.0E+07 cycles.

In at least one variation, the alpha-beta product composition comprises 6.4-7.4 wt. % Al, 2.1-2.6 wt. % Mo, 0.5-1.5 wt. % Nb, 1.0-1.8 Sn, 0.5-1.5 wt. % Zr, 0.1-0.3 wt. % Si, 0.1-0.15 wt. % O, with the remainder being Ti and incidental impurities. And in such variations, the heat treated alpha-beta product comprises a tensile strength greater than about 153 ksi, a yield strength greater than about 130 ksi, a percent elongation greater than about 3%, and an elastic modulus greater than about 17.5 Msi at 75° F. (23.9° C.). In addition, the heat treated alpha-beta product comprises a tensile strength greater than about 90 ksi, a yield strength greater than about 68 ksi, a percent elongation greater than about 15%, and an elastic modulus greater than about 13.0 Msi at 1150° F. (621.1° C.).

In some variations, the alpha-beta product composition comprises 6.8-7.6 wt. % Al, 0.8-1.6 wt. % Mo, 1.6-2.4 wt. % Nb, 0.15-0.45 Sn, 0.1-0.3 wt. % Zr, 0.1-0.3 wt. % Si, 0.1-0.2 wt. % O, with the remainder being Ti and incidental impurities. And in such variations, the heat treated alpha-beta product has an elastic modulus greater than about 10.0 Msi at 1150° F. (621.1° C.).

In at least one variation, the alpha-beta product composition comprises 5.7-6.7 wt. % Al, 1.7-2.3 wt. % Mo, 1.8-2.4 wt. % Nb, 2.4-3.2 Sn, 1.8-2.6 wt. % Zr, 0.1-0.3 wt. % Si, 0.1-0.2 wt. % O with the remainder being Ti and incidental impurities. And in such variations, the heat treated alpha-beta product has a tensile strength greater than about 155 ksi, a percent elongation greater than about 3%, and an elastic modulus greater than about 17.0 Msi at 75° F. (23.9° C.). In addition, the heat treated alpha-beta product has a tensile strength greater than about 95 ksi, a yield strength greater than about 73 ksi, a percent elongation greater than about 16%, and an elastic modulus greater than about 12.0 Msi at 1150° F. (621.1° C.).

In another form of the present disclosure, an alpha-beta titanium alloy includes a composition in weight percent (wt. %) comprising 5.7-7.5 wt. % Al, 0.8-4.2 wt. % Mo, 0.0-3.0 wt. % Nb, 0.1-3.5 Sn, 0.1-3.0 wt. % Zr, 0.1 0.35 wt. % Si, 0.05-0.25 wt. % O, with the remainder being Ti and incidental impurities. The alpha-beta titanium alloy also has an acicular microstructure comprising needles of alpha in a matrix of beta, and an EN 6072 testing fatigue life of more than 1.0E+07 cycles.

In some variations, the alpha-beta titanium alloy has or exhibits a time to reach 0.25% strain at 35 ksi and 950° F. (510° C.) of greater than 50 hours, for example greater than 75 hours, or greater than 100 hours.

In at least one variation, the composition of the alpha-beta titanium alloy comprises 6.4-7.4 wt. % Al, 2.1-2.6 wt. % Mo, 0.5-1.5 wt. % Nb, 1.0-1.8 Sn, 0.5 -1.5 wt. % Zr, 0.1-0.3 wt. % Si, 0.1-0.15 wt. % O, with the remainder being Ti and incidental impurities. And in such variations, the alpha-beta titanium alloy has a tensile strength greater than about 153 ksi, a yield strength greater than about 130 ksi, a percent elongation greater than about 3%, and an elastic modulus greater than about 17.5 Msi at 75. In addition, the alpha-beta titanium alloy has a tensile strength greater than about 90 ksi, a yield strength greater than about 68 ksi, a percent elongation greater than about 15%, and an elastic modulus greater than about 13.0 Msi at 1150° F. (621.1° C.).

In some variations, the alpha-beta titanium alloy has a composition of 6.8-7.6 wt. % Al, 0.8-1.6 wt. % Mo, 1.6- 2.4 wt. % Nb, 0.15-0.45 Sn, 0.1-0.3 wt. % Zr, 0.1-0.3 wt. % Si, 0.1-0.2 wt. % O, with the remainder being Ti and incidental impurities. And in such variations, the alpha-beta titanium alloy has an elastic modulus greater than about 10.0 Msi at 1150° F. (621.1° C.).

In at least one variation the composition of the alpha-beta titanium alloy comprises 5.7-6.7 wt. % Al, 1.7-2.3 wt. % Mo, 1.8-2.4 wt. % Nb, 2.4-3.2 Sn, 1.8-2.6 wt. % Zr, 0.1-0.3 wt. % Si, 0.1-0.2 wt. % O, with the remainder being Ti and incidental impurities. And in such variations, the alpha-beta titanium alloy has a tensile strength greater than about 155 ksi, a percent elongation greater than about 3%, and an elastic modulus greater than about 17.0 Msi at 75° F. (23.9° C.), and a tensile strength greater than about 95 ksi, a yield strength greater than about 73 ksi, a percent elongation greater than about 16%, and an elastic modulus greater than about 12.0 Msi at 1150° F. (621.1° C.).

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a table with composition and calculated data for a range of alloys according to the teachings of the present disclosure;

FIG. 2 shows a table of heat treat conditions for a range of alloys according to the teachings of the present disclosure;

FIG. 3A is a photomicrograph of the B15043 heat alloy after being subjected to a standard heat treatment according to the teachings of the present disclosure;

FIG. 3B is another photomicrograph of the B15043 heat alloy after being subjected to the standard heat treatment according to the teachings of the present disclosure;

FIG. 4A is a photomicrograph of the B15046 heat alloy after being subjected to a triplex heat treatment according to the teachings of the present disclosure;

FIG. 4B is another photomicrograph of the B15046 heat alloy after being subjected to the triplex heat treatment according to the teachings of the present disclosure;

FIG. 5A is a photomicrograph of the B15047 heat alloy after being subjected to a triplex heat treatment according to the teachings of the present disclosure;

FIG. 5B is another photomicrograph of the B15047 heat alloy after being subjected to the triplex heat treatment according to the teachings of the present disclosure;

FIG. 6A is a photomicrograph of the B15050 heat alloy after being subjected to a triplex heat treatment according to the teachings of the present disclosure;

FIG. 6B is another photomicrograph of the B15050 heat alloy after being subjected to the triplex heat treatment according to the teachings of the present disclosure;

FIG. 7A is a photomicrograph of the H24993 heat alloy after being subjected to a standard heat treatment according to the teachings of the present disclosure;

FIG. 7B is another photomicrograph of the H24993 heat alloy after being subjected to the standard heat treatment according to the teachings of the present disclosure;

FIG. 8A is a photomicrograph of the H19794 heat alloy after being subjected to a standard heat treatment according to the teachings of the present disclosure;

FIG. 8B is another photomicrograph of the H19794 heat alloy after being subjected to the standard heat treatment according to the teachings of the present disclosure;

FIG. 9 is a plot of tensile property data at 75° F. (23.9° C.) for a range of alloys according to the teachings of the present disclosure;

FIG. 10 is a plot of tensile property data at 1150° F. (621.1° C.) for a range of alloys according to the teachings of the present disclosure;

FIG. 11 is a plot of tensile elastic modulus data at 75° F. (23.9° C.) and 1150° F. (621.1° C.) for a range of alloys according to the teachings of the present disclosure;

FIG. 12 is a plot of creep data for a range of alloys according to the teachings of the present disclosure;

FIG. 13 is a plot of fatigue life data for a range of alloys according to the teachings of the present disclosure;

FIG. 14A is a line drawing of a fatigue sample per the EN 6072 standard specification;

FIG. 14B is a table of fatigue test conditions per the EN 6072 standard specification;

FIG. 15 is a table showing a summary of tensile, creep, and fatigue testing data for a range of alloys according to the teachings of the present disclosure;

FIG. 16 is a table showing a summary of improvements for a range of alloys according to the teachings of the present disclosure compared to commercial Ti21S and Ti6242 alloys; and

FIG. 17 is a table showing the range of alloying elements for alloys according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides one or more titanium (Ti) alloys with improved elevated temperature properties such as strength, stiffness, creep, and fatigue life, among others, compared to known commercial alloys like the Ti6242 and Ti21S alloys. In addition, the one or more Ti alloys according to the teachings of the present disclosure have a density and cost generally equal to or less than the Ti6242 alloy and less than the Ti21S alloy.

The Ti alloy of the present disclosure includes aluminum (Al), molybdenum (Mo), tin (Sn), zirconium (Zr), silicon (Si), and oxygen (O) with a balance of Ti and unavoidable trace elements. And in some variations the Ti alloy includes niobium (Nb).

Aluminum is an alpha stabilizer and also enhances strength and microstructural control. Microstructural control is desired for proper fabrication/manufacturing because the microstructure is closely related to process parameters such as temperature, strain rate, strain, and their interactions. When the aluminum content is less than 5.5 wt. %, the effect of solution hardening is less pronounced, therefore the desired strength cannot be achieved. When the aluminum content exceeds 7.5 wt. %, the beta transus temperature becomes too high and resistance to hot formability is increased. Accordingly, the aluminum content of the present disclosure is in the range of about 5.5 to about 7.5 wt. %.

Molybdenum (Mo) is a beta stabilizing element and is effective for grain refinements. If the molybdenum content is lower than 1.0 wt. %, sufficient beta stability will not be obtained. On the other hand, if the molybdenum content is higher than 4.5 wt. %, the beta phase will may excessively stabilized, and the molybdenum will also increase density above a target value of less than about 4.60 g/cm³. Accordingly, it was determined that the molybdenum content for the present disclosure is in the range of about 1.0 wt. % to about 4.5 wt. %.

Niobium, when present in one or more alloys according to the teachings of the present disclosure, is a beta stabilizing element and is effective for increasing room temperature strength and enhancing heat treatment and forming capabilities of the alloy. However, if the Nb is higher than about 3.0 wt. %, the beta phase may be excessively stabilized, and the Nb will also increase density above a target value of less than about 4.60 g/cm³.

Tin and Zr are both alpha stabilizing elements and are effective for solid solution strengthening. If the Sn or Zr content is lower than about 0.1 wt. %, sufficient alpha stability and strength will not be obtained. However, if the Sn content is higher than about 3.5 wt. % or the Zr content is higher than 3.0 wt. %, ductility of the alloy is less than desired. Accordingly, it was determined that the Sn content for the present disclosure is in the range of about 0.1 wt. % to about 3.5 wt. % and the Zr content for the present disclosure is in the range of about 0.1 wt. % to about 3.0 wt. %.

Silicon is known to add strength to titanium alloys by a combination of solution strengthening and formation of precipitates of titanium silicides. If the Si content is lower than about 0.1 wt. %, sufficient strength will not be obtained. However, if the Si content is higher than about 0.35 wt. % ductility of the alloy is less than desired. Accordingly, it was determined that the Si content for the present disclosure is in the range of about 0.1 wt. % to about 0.35 wt. %.

Oxygen is an alpha stabilizing element and is effective for solid solution strengthening. If the O content is lower than about 0.05 wt. %, strength will not be obtained. However, if the O content is higher than about 0.25 wt. %, ductility of the alloy is less than desired. Accordingly, it was determined that the 0 content for the present disclosure is in the range of about 0.05 wt. % to about 0.25 wt. %.

Trace elements such as carbon (C), iron (Fe) and nitrogen (N) are kept below 0.1 wt. % in the alloy. For example, C is kept below 0.05 wt. %, and in some variations C is maintained below 0.01 wt. %. Also, Fe and N can be kept below 0.05 wt. %.

A beta transus (BT) of the alloys is between about 1775° F. and about 1925° F., where the BT in degrees Fahrenheit is calculated from the expression: BT=1615 +39.3Al+3300+1145C+1020N−32.5Fe−17.3Mo-70Si−5Sn-9Nb-10Zr, with Al, O, C, N, Fe, Mo, Si, Sn, Nb, and Zr being the content of each element in the alloy in weight percent. In at least one variation the BT of one or more of the alloys is between about 1790° F. and about 1905° F. In some variations the AE of the alloy is between 1795° F. and about 1900° F. And in at least one variation the AE of the alloy is between 1799° F. and about 1895° F.

An aluminum equivalence (AE) of the alloys is between about 8.0 and about 9.0, where the AE in weight percent is defined by the expression: AE=Al+10(O+C+2N)+Sn/3+Zr/6+0.3 Si, with Al, O, C, N, Sn, Zr, and Si being the content of each element in the alloy in weight percent. In at least one variation the AE of the alloy is between about 8.0 and about 8.8. In some variations the AE of the alloy is between about 8.4 and about 9.0. And in at least one variation the AE of the alloy is between about 8.4 and about 8.8.

A molybdenum equivalence (ME) of the alloys is between about 1.5 and about 4.5, where the ME in weight percent is defined by the expression: ME=Mo+0.27Nb+Fe/0.35, with Mo, Nb, and Fe being the content of each element in the alloy in weight percent. In at least one variation the ME of the alloy is between about 1.5 and about 4.0. In some variations the ME of the alloy is between about 1.8 and about 4.5. And in at least one variation the ME of the alloy is between about 1.8 and about 4.0.

Accordingly, Ti alloys according to the teachings have a composition with 5.7-7.5 wt. % Al, 0.8-4.2 wt. % Mo, 0.0-3.0 wt. % Nb, 0.1-3.5 Sn, 0.1-3.0 wt. % Zr, 0.1-0.35 wt. % Si, 0.05-0.25 wt. % O, with the remainder being Ti and incidental impurities. For example, in some variations, one or more Ti alloys have a composition with 6.4-7.4 wt. % Al, 2.1-2.6 wt. % Mo, 0.5-1.5 wt. % Nb, 1.0-1.8 Sn, 0.5-1.5 wt. % Zr, 0.1-0.3 wt.% Si, 0.1-0.15 wt.% O, with the remainder being Ti and incidental impurities. In other variations one or more Ti alloys have a composition with 6.8-7.6 wt. % Al, 0.8-1.6 wt. % Mo, 1.6-2.4 wt. % Nb, 0.15-0.45 Sn, 0.1-0.3 wt. % Zr, 0.1-0.3 wt. % Si, 0.1-0.2 wt. % O, with the remainder being Ti and incidental impurities. And in at least one variation, one or more Ti alloys have a composition with 5.7 - 6.7 wt. % Al, 1.7-2.3 wt. % Mo, 1.8-2.4 wt. % Nb, 2.4-3.2 Sn, 1.8-2.6 wt. % Zr, 0.1-0.3 wt. % Si, 0.1-0.2 wt. % O, with the remainder being Ti and incidental impurities.

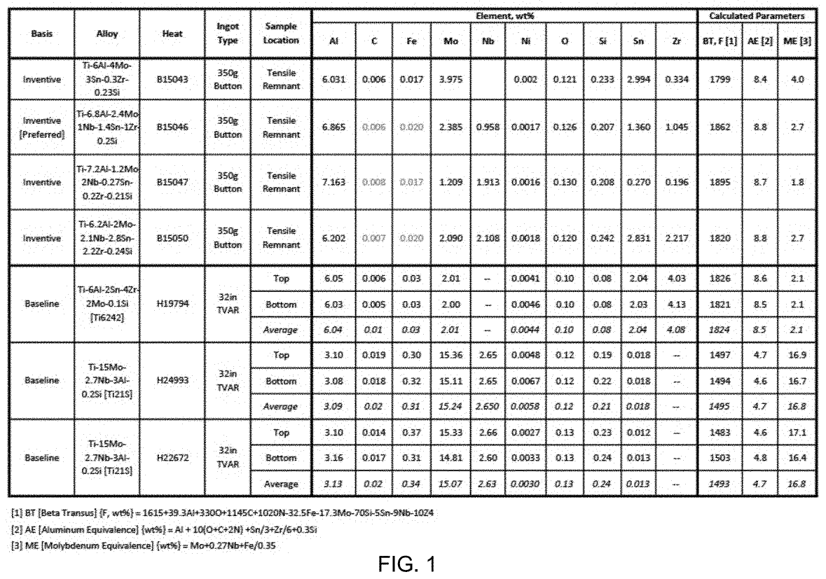

Referring now to FIG. 1, a table with compositions for Ti alloys that were prepared and tested, along with respective calculated BT, AE, and ME values for the Ti Alloys, is shown. Particularly, compositions and calculated BT, AE, ME values for alloys (heats) according to the teachings of the present disclosure are shown or labeled as Heat B15043 (referred to herein simply as “B15043”), Heat B15046 (referred to herein simply as “B15046”), Heat B15047 (referred to herein simply as “B15047”), and Heat B15050 (referred to herein simply as “B15050”). In addition, compositions and calculated BT, AE, ME values for commercial alloys used as “baseline alloys” for comparison are shown or labeled as Heat H19794 corresponding to the Ti6242 alloy (referred to herein simply as “H19794”), Heat H24993 corresponding to the Ti21S alloy (referred to herein simply as “H24993”), and Heat H22672 corresponding to the Ti21S alloy (referred to herein simply as “H22672”).

The B15043, B15046, B15047, and B15050 alloys were each prepared by plasma melting a 350 gram (g) button having the respective alloy composition, hot rolling the 350 g button to an intermediate product or thickness at a temperature above the beta transus, hot rolling the intermediate product to a final product or thickness at a temperature below the beat transus, subjecting the final product to a final heat treatment, and then machine the final product into test specimens with a thickness of about 0.116 inches (in). The nominal or average size for each 350 g alloy button was about 0.2 in thick, about 2 in wide, and about 11 in long (i.e., 0.2 in×2 in×11 in). in addition, and given surface finishing typically required on production plate or sheet, the approximate 0.2 in as-rolled thickness of the B15043, B15046, B15047, and B15050 alloys corresponded to 0.16 in finished mill product thickness which was the same as the baseline Ti6242 alloy specimens discuss below.

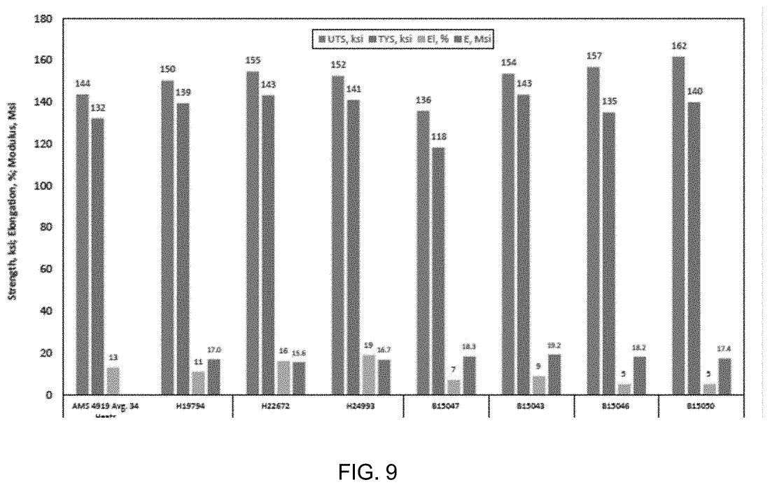

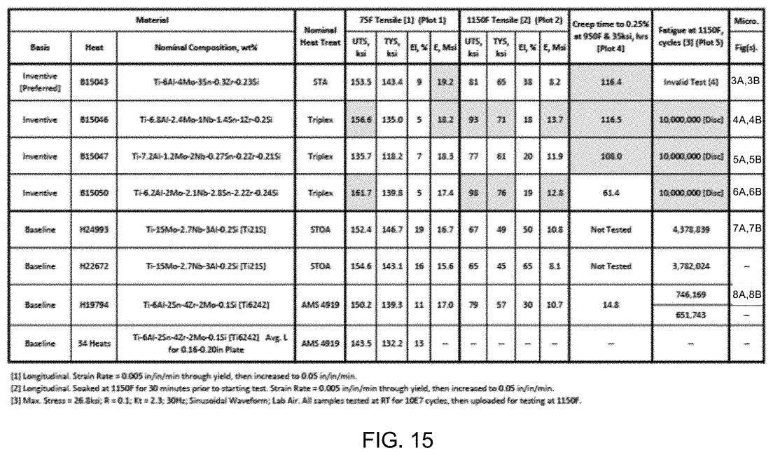

The H19794, H24993, and H22672 alloys (i.e., the comparative baseline alloys) were prepared or taken from full-scale heats certified to AMS and other aerospace specification. Particularly, material for the H19794 alloy specimens were taken from a full-scale heat certified to AMS 4919 and other relevant aerospace specifications such that material from Heat H19794 was sold to OEMs for use on civil and military aircraft for aeroengine exhaust systems, heat shields, and other structural components subjected to high or elevated temperatures. Also, material for the H24993 and H22672 alloy specimens were taken from full-scale heats certified to AMS 4897 and other relevant aerospace specifications. It should be understood that the Heat H19794 material is representative of the Ti6242 alloy, however, and as shown in FIGS. 9 and 15, the strength of this particular heat is on the high side of historical production by about 7 ksi. In addition, the AMS 4919 specification is for sheet and plate and has no creep requirement specified, such that the flat-roll products produced from the Heat H19794 material do not necessarily have the same creep capability as Ti6242 forgings manufactured specifically for creep-critical applications.

In some variations, the B15043 composition in FIG. 1 is representative of a Ti alloy with a composition of 5.7-6.3 wt. % Al, 3.7-4.3 wt. % Mo, 2.7-3.3 Sn, 0.1-0.6 wt. % Zr, 0.1-0.4 wt. % Si, 0.05-0.2 wt. % O, with the remainder being Ti and incidental impurities. And in at least one variation, the B15046 composition in FIG. 1 is representative of a Ti alloy with a composition of 6.6-7.2 wt. % Al, 2.1-2.7 wt. % Mo, 1.1-1.7 Sn, 0.7-1.3 wt. % Zr, 0.1-0.4 wt. % Si, 0.05-0.2 wt. % O, with the remainder being Ti and incidental impurities.

In some variations, the B15047 composition in FIG. 1 is representative of a Ti alloy with a composition of 6.9-7.5 wt. % Al, 0.9-1.5 wt. % Mo, 0.1-0.6 Sn, 0.1-0.5 wt. % Zr, 0.1-0.4 wt. % Si, 0.05-0.2 wt. % O, with the remainder being Ti and incidental impurities. And in at least one variation, the B15050 composition in FIG. 1 is representative of a Ti alloy with a composition of 5.9-6.5 wt. % Al, 1.8-2.4 wt. % Mo, 2.5-3.1 Sn, 1.9-2.5 wt. % Zr, 0.1-0.4 wt. % Si, 0.05-0.2 wt. % O, with the remainder being Ti and incidental impurities.

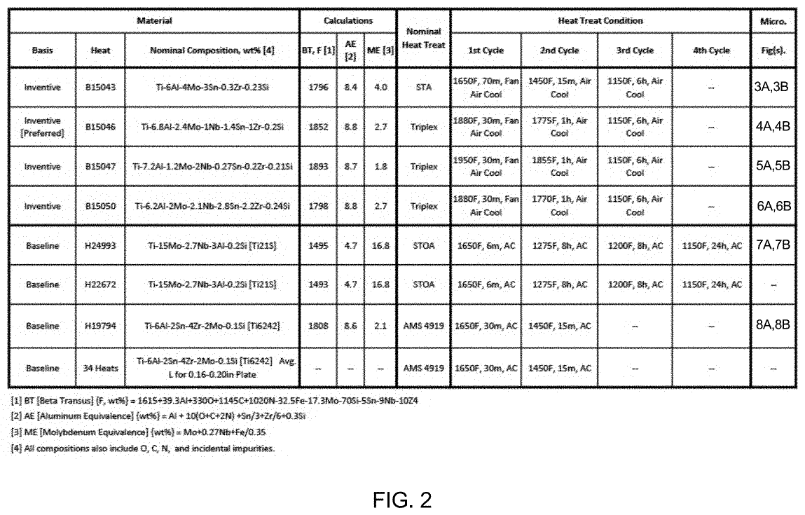

Heat treatment parameters for each alloy are provided in the table shown in FIG. 2. Particularly, the B15043 alloy specimens were subjected to a sub-transus anneal (STA) heat treatment (i.e., an initial cycle or step below the beta transus) of 1650° F. (898.9° C.) for 70 minutes followed by fan air cooling, then 1450° F. (787.7° C.) for 15 minutes followed by air cooling, and then 1150° F. (621.1° C.) for 6 hours followed by air cooling. The B15046 alloy specimens were subjected to a “Triplex” heat treatment (i.e., an initial cycle or step above the beta transus) of 1880° F. (1026.7° C.) for 30 minutes followed by fan air cooling, then 1775° F. (968.3° C.) for 1 hours followed by air cooling, and then 1150° F. (621.1° C.) for 6 hours followed by air cooling. The B15047 alloy specimens were subjected to a Triplex heat treatment of 1950° F. (1056.6° C.) for 30 minutes followed by fan air cooling, then 1855° F. (1012.8° C.) for 1 hours followed by air cooling, and then 1150° F. (621.1° C.) for 6 hours followed by air cooling. And the B15050 alloy specimens were subjected to a Triplex heat treatment of 1880° F. for 30 minutes followed by fan air cooling, then 1770° F. (965.6° C.) for 1 hours followed by air cooling, and then 1150° F. (621.1° C.) for 6 hours followed by air cooling.

The H24993 and H22672 alloy specimens were subjected to a sub-transus anneal 4 cycle/step heat treatment (STOA) of 1650° F. for 6 minutes followed by air cooling, then 1275° F. (690.6° C.) for 8 hours followed by air cooling, then 1200° F. (648.9° C.) for 8 hours followed by air cooling, and then 1150° F. (621.1° C.) for 24 hours followed by air cooling. The H19794 alloy specimens were subjected to the two cycle/step AMS 4919 heat treatment of 1650° F. for 30 minutes followed by air cooling, and then 1450° F. (787.8° C.) for 15 minutes followed by air cooling, which is also shown in FIG. 2 for 34 separate heats used to develop average properties for the Ti6242 alloy per the

AMS 4919 specification.

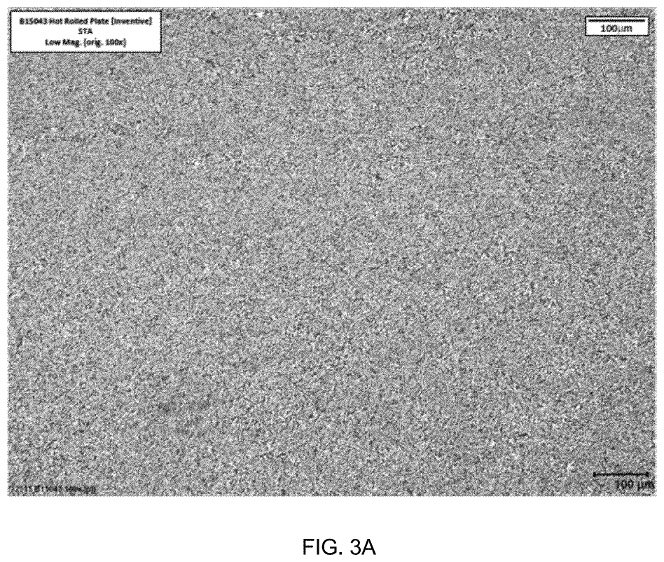

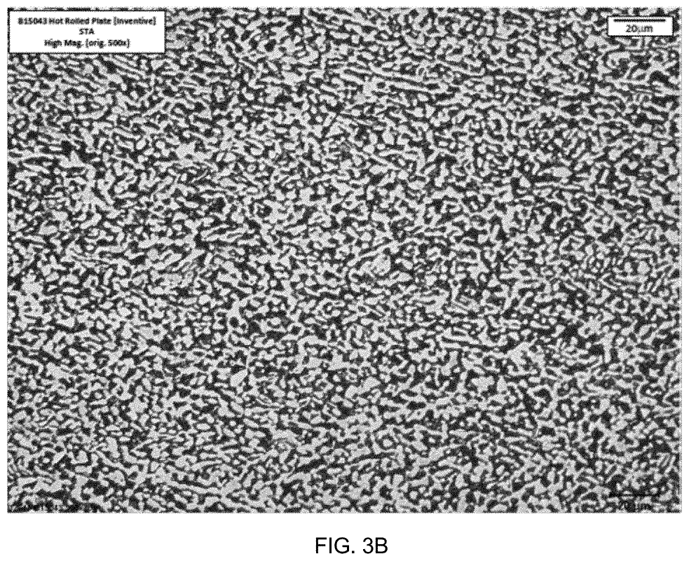

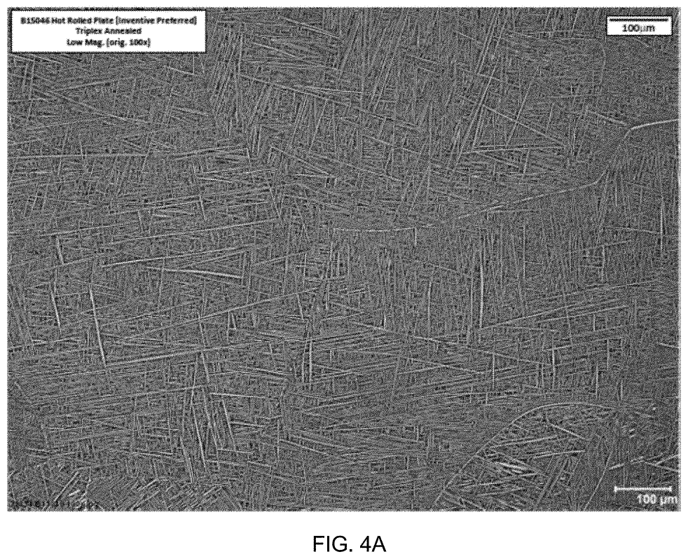

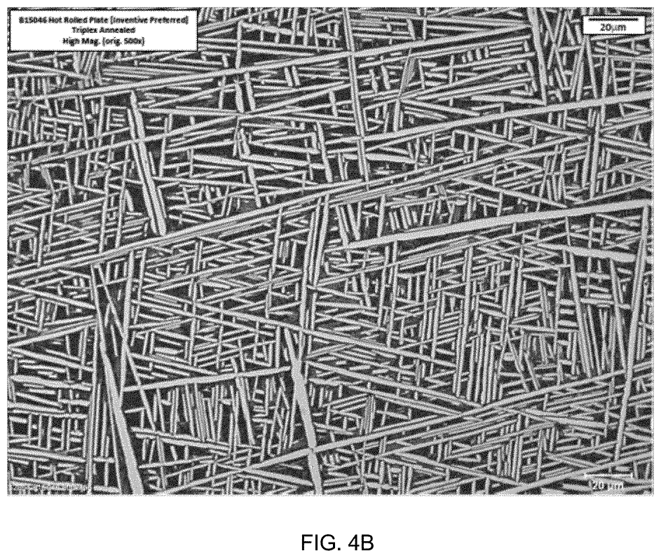

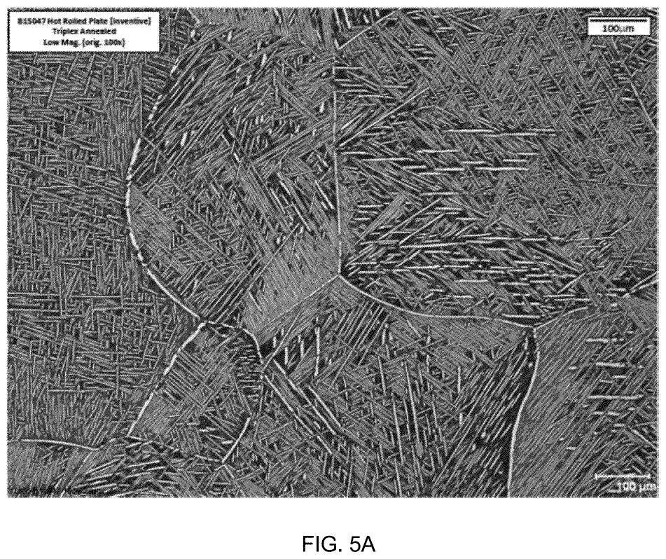

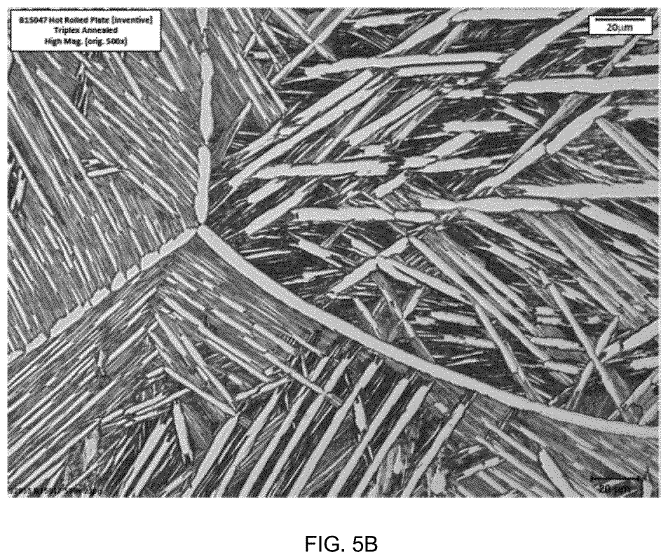

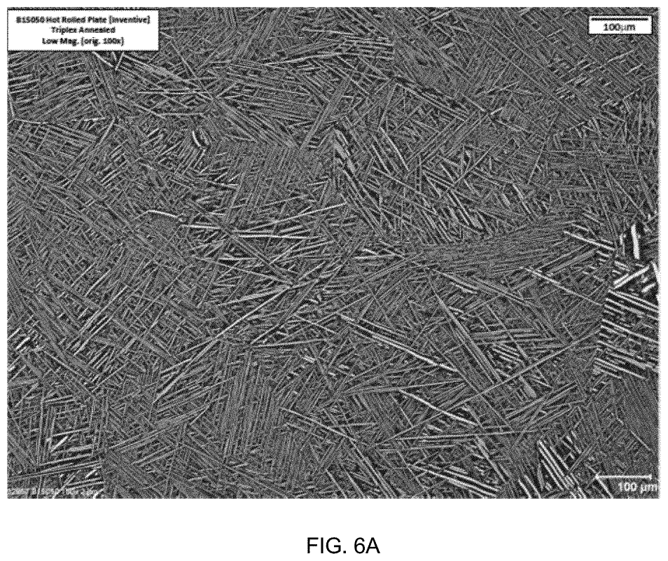

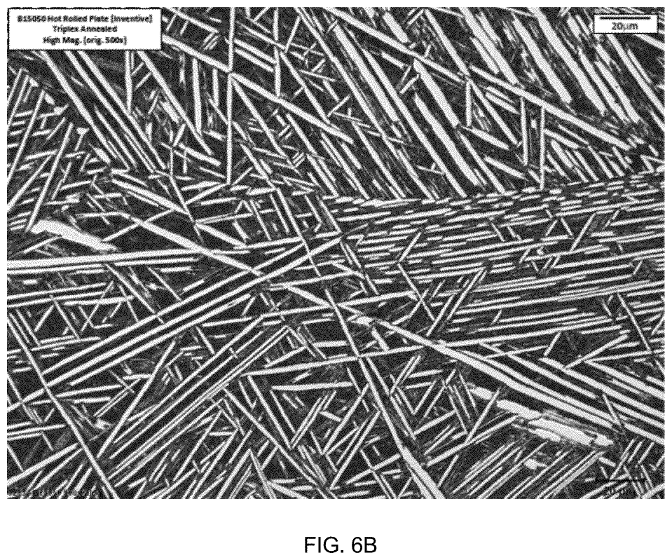

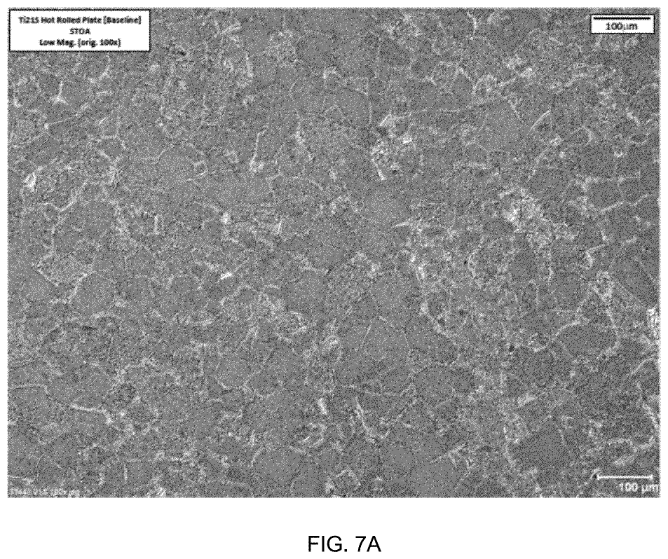

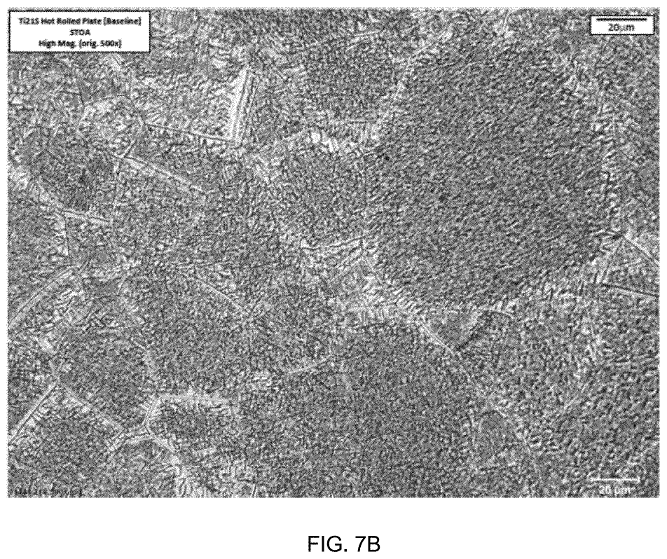

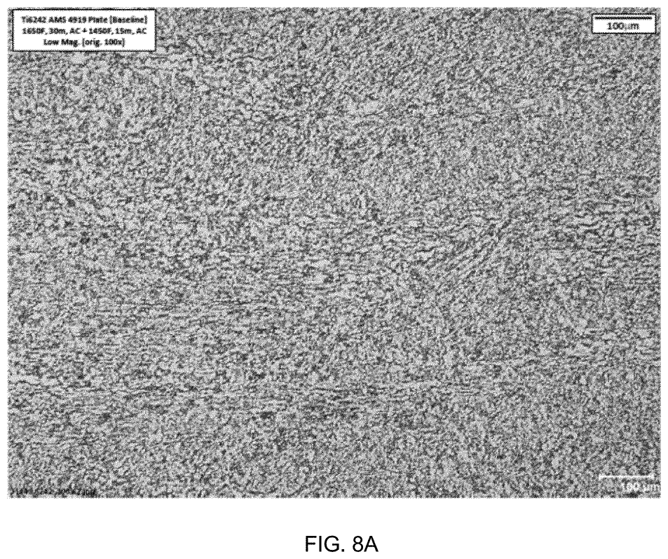

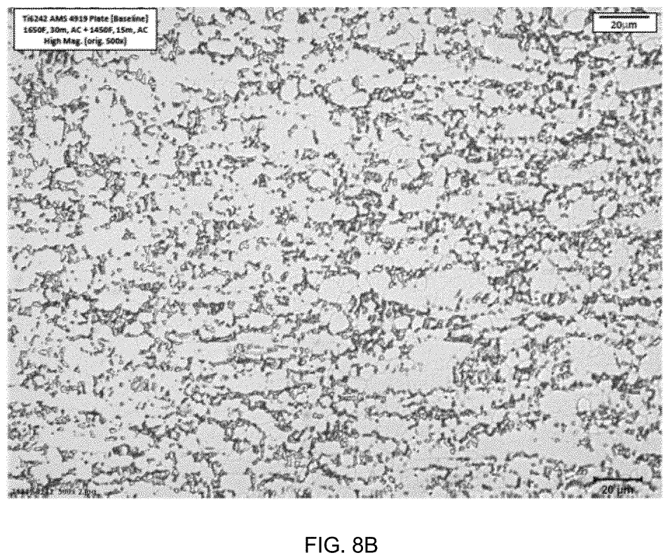

Microstructures for the heat treated specimens are shown in FIGS. 3A-8B with FIGS. 3A-3B showing the microstructure of the B154043 alloy specimens after being subjected to the STA heat treatment, FIGS. 4A-4B showing the microstructure of the B154046 alloy specimens after being subjected to the triplex heat treatment noted above, FIGS. 5A-5B showing the microstructure of the B154047 alloy specimens after being subjected to the triplex heat treatment noted above, and FIGS. 6A-6B showing the microstructure of the B154050 alloy specimens after being subjected to the triplex heat treatment noted above. Also, FIGS. 7A-7B show the H24993 alloy specimens after being subjected to the STOA heat treatment noted above and FIGS. 8A-8B show the H19794 alloy specimens after being subjected to the STOA heat treatment noted above.

It should be understood that the triplex heat treatments produced microstructures in the B154046, B154047, and B154050 alloy specimens (FIGS. 4A-6B) considered unconventional for elevated temperature applications or testing discussed below. Particularly, an acicular microstructure with acicular or needle shape alpha in a matrix of beta was produced in the B154046, B154047, and B154050 alloy specimens and such microstructures are not expected to be associated with enhanced elevated temperature properties, particularly creep and elevated temperature fatigue, as discussed for these alloys below.

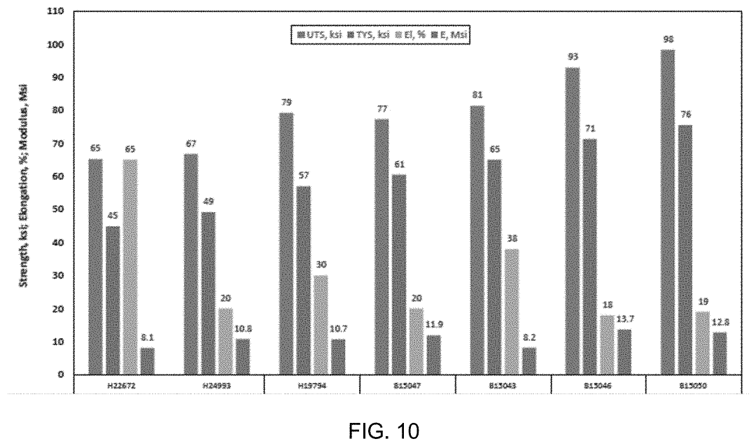

Referring now to FIGS. 9 and 10, tensile properties at room temperature (i.e., 75° F.) and 1150° F. (621.1° C.), respectively, for the alloys shown in FIG. 1 are shown. Tensile testing of the alloy specimens at room temperature was performed per ASTM E 8 and tensile testing at 1150° F. (621.1° C.) was performed per ASTM E 21. Also, the tensile testing performed on the longitudinal direction of uncoated alloy specimens in laboratory air.

The room temperature tensile results for the B15046 alloy (Ti-6Al-2.6Mo-1Nb-1.4Sn-1.1Zr-0.24Si) were 157 ksi UTS, 135 ksi TYS, 5% elongation, and 18.2 Msi elastic modulus. The strength values were similar to the baseline heat, and readily exceed the averages for production Ti6242. Also, was a significant increase (˜12%) in elastic modulus. And although the elongation value was lower than that of the baseline Ti6242 (5% vs 11%), at least some of the potential impacts of low ductility is accounted for by the favorable notched high cycle fatigue results discussed below. In addition, the B15050 alloy (Ti-6.2A1-2Mo-2.1Nb-2.8Sn-2.2Zr-0.24Si (B15050) exhibited the highest strength.

The 1150° F. (621.1° C.) tensile test results for the B15046 alloy (Ti-6Al-2.6Mo-1Nb-1.4Sn-1.1Zr-0.24Si) were 93 ksi UTS, 71 ksi TYS, 18% elongation, and 13.7 Msi elastic modulus. The strength values were significantly higher than the baseline heat (by 14 ksi) and there was a significant increase (˜22%) in elastic modulus. It should be understood that the relatively large increase in stiffness at elevated temperature is an unexpected result. In addition, the B15050 alloy (Ti-6.2A1-2Mo-2.1Nb-2.8Sn-2.2Zr-0.24Si (B15050) again exhibited the highest strength.

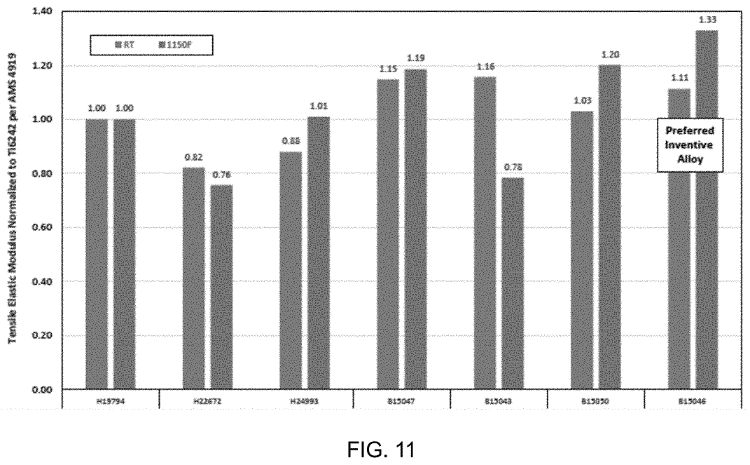

It should be understood that density is an important attribute for Ti alloys, especially for components that are designed at minimum gage for stiffness considerations, e.g., for aeroengine exhaust ducts applications. In addition, it would be desirable for a Ti alloy to have a density less than the Ti6242 alloy, but with higher stiffness at elevated temperature. And given that the calculated density of the B15046 alloy (Ti-6.8A1-2.4Mo-1Nb-1.4Sn-1Zr-0.2Si) is about 3.6% less than that of the Ti6242 alloy, tensile elastic modulus for each of the tested alloys was determined at room temperature and 1150° F. (621.1° C.) (FIG. 15), and then normalized relative to the AMS 4919 Ti6242 alloy specification as shown in FIG. 11. Accordingly, for components designed to a minimum thickness of material at elevated temperature, the B15406 provides an approximate 33% increase in tensile elastic modulus compared to the Ti6242 alloy (FIG. 11).

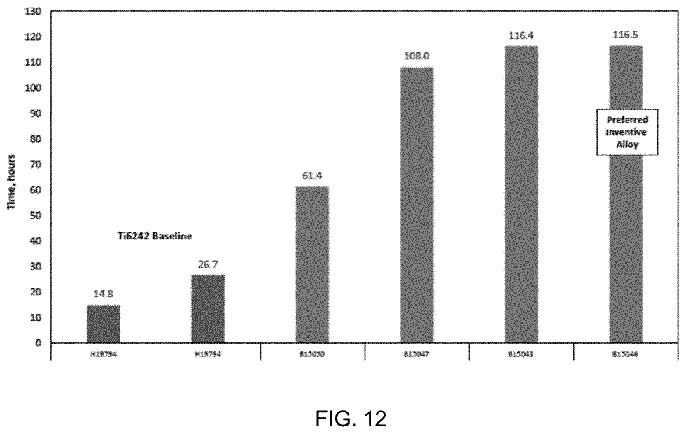

Referring now to FIG. 12, creep test results for the tested alloys are shown, with the data shown in FIG. 12 representing the time for a test specimen to reach 0.25% strain when held at 950° F. (510° C.) under a 35 ksi load. It should be understood that these parameters are known to be greater or more severe than anticipated for most aeroengine exhaust applications, but are considered meaningful for screening purposes. And compared to the baseline Ti6242 alloy, the B15046 alloy (Ti-6.8A1-2.4Mo-1Nb-1.4Sn-1Zr-0.2Si) in the triplex heat treat condition exceeded the time to reach 0.25% at 950° F. (510° C.) and 35 ksi by a factor of about eight (8×). Also, the B15403 alloy (Ti-6Al-4Mo-3Sn-0.3Zr-0.23Si) in the STA heat treat condition also exhibited an 8× improvement compared to the baseline Ti6242 alloy and this should be considered an unexpected result since the sub-transus microstructure of the B15403 alloy specimens (FIGS. 3A-3B), which is associated with a combination of enhanced strength and ductility at 1150° F. (621.1° C.) (FIG. 10), is not typically associated with enhanced creep properties. It should also be understood that the Ti6242 AMS 4919 plate does not appear to have as high a creep resistance as would be expected for Ti6242 forgings manufactured for aeroengine applications. However, and given the Ti6242 alloy is used on current-production aircraft, the Ti6242 plate is considered to be a legitimate baseline for the hot flat rolled alloys (i.e., the B15403, B15406, B15047, B15050 alloys) of the present disclosure.

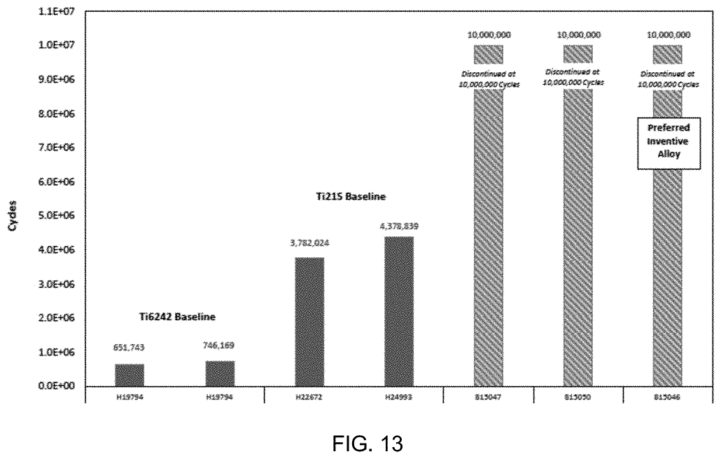

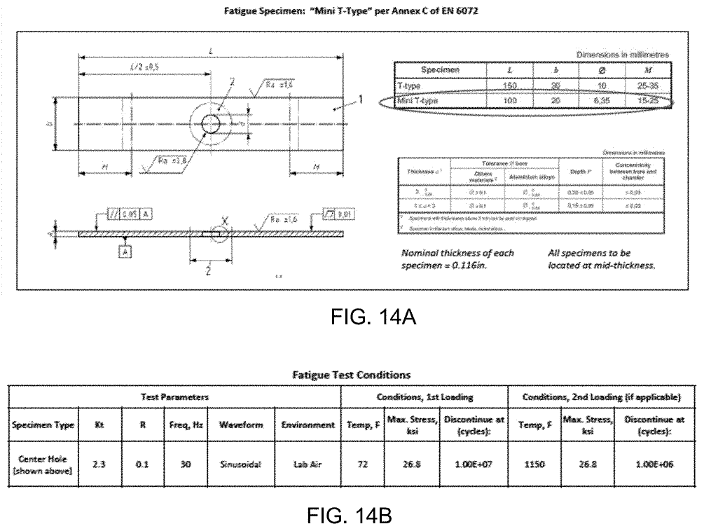

Referring now to FIG. 13, fatigue results for the tested alloys are shown. The fatigue specimen geometry is shown in FIG. 14A and specimens for each alloy were machined using the same practices such that the same surface finish and dimensions for all of the alloy specimens were obtained. Also, the alloy specimens were fatigue tested as-machined, i.e., with no surface conditioning or coatings. The fatigue parameters are shown in FIG. 14B and these parameters were selected to be relevant to high temperature aeroengine exhaust applications which typically experience lower stresses (less than about 30 ksi) but very high numbers of cycles (more than about 10 million).

Due to the microstructure of the triplex annealed experimental alloys, especially with the concomitant reduction in tensile elongation, it was anticipated that the inventive compositions would have a reduced fatigue life. It seemed probable that these compositions would not even survive the full 10 million cycles at room temperature and therefore would not even make it to the testing at 1150° F. (621.1° C.). The unexpected result was that the inventive compositions had a significant increase in fatigue life, especially in comparison to the Ti6242 alpha-beta baseline alloy. Not only did they survive the full 10 million cycles at room temperature, but also the subsequent 10 million cycles at 1150° F. (621.1° C.). Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

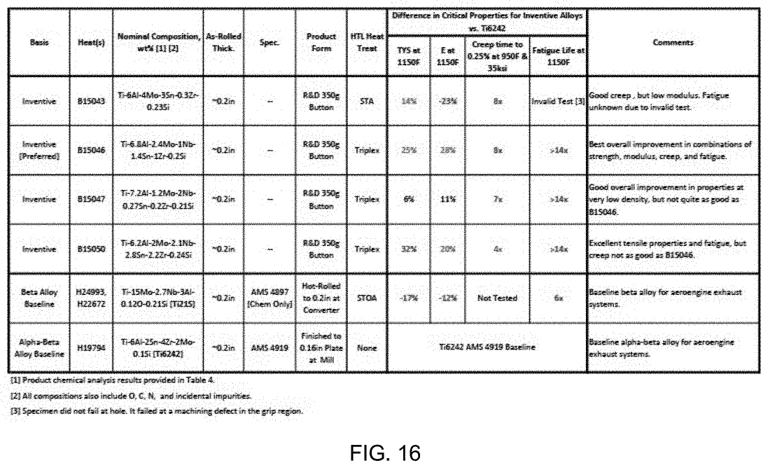

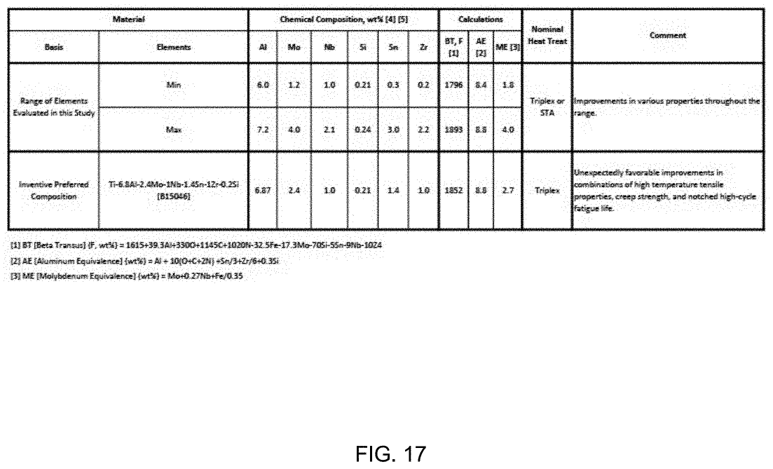

Referring to FIG. 15, a summary of the room temperature and 1150° F. (621.1° C.) tensile test data, creep test data, and fatigue data are shown. In addition, FIG. 16 shows a summary of the improvement of the B15403, B15406, B15047, B15050 alloys compared to the Ti5242 alloy and FIG. 17 shows ranges of the alloying elements present in the B15403, B15406, B15047, B15050 alloys.

It should also be understood that the elemental ranges discussed herein include all incremental values between the minimum alloying element composition and maximum alloying element composition values. That is, a minimum alloying element composition value can range from the minimum value to the maximum value. Likewise, the maximum alloying element composition value can range from the maximum value shown to the minimum value discussed. For example, the minimum Al content can be 5.7, 5.8, 5.9, 6.0, 6.1, 6.2, 6..3, 6.4, 6.5, 6.6, 6.7, 6.8, 6.9, 7.0, 7.1, 7.2, 7.3, 7.4, 7.5, and any value between these incremental values, and the maximum Al content can be 7.5, 7.4, 7.3, 7.2, 7.1, 7.0, 6.9, 6.8, 6.7, 6.6, 6.5, 6.4, 6.3, 6.2, 6.1, 6.0, 5.9, 5.8, 5.7, and any value between these incremental value.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of manufacturing an alpha-beta titanium alloy, the method comprising:
forming an alpha-beta product from a titanium alloy with a composition in weight percent (wt. %) comprising 5.7-7.5 wt. % Al, 0.8-4.2 wt. % Mo, 0.0-3.0 wt. % Nb, 0.1-3.5 Sn, 0.1-3.0 wt. % Zr, 0.1-0.35 wt. % Si, 0.05-0.25 wt. % O, with a remainder being Ti and incidental impurities; and
heat treating the alpha-beta product with a first heat treatment step comprising a first temperature and a first time, a second heat treatment step comprising a second temperature and a second time, and a third heat treatment step comprising a third temperature less than the second temperature and a third time greater than the second time.

2. The method according to claim 1, wherein the first temperature is between 1600° F. and 2000° F. and the first time is between 15 minutes and 120 minutes.

3. The method according to claim 2, wherein the second temperature is between 1400° F. and 1900° F. and the second time is between 5 minutes and 90 minutes.

4. The method according to claim 3, wherein the third temperature is between 1050° F. and 1250° F. and the third time is between 5 hours and 7 hours.

5. The method according to claim 1, wherein the heat treated alpha-beta product comprises an acicular microstructure.

6. The method according to claim 5, wherein the acicular microstructure comprises needles of an alpha phase in a matrix of a beta phase.

7. The method according to claim 1, wherein the alpha-beta product composition comprises 6.4-7.4 wt. % Al, 2.1-2.6 wt. % Mo, 0.5-1.5 wt. % Nb, 1.0-1.8 Sn, 0.5-1.5 wt. % Zr, 0.1-0.3 wt. % Si, 0.1-0.15 wt. % O, with the remainder being Ti and incidental impurities.

8. The method according to claim 1, wherein the alpha-beta product composition comprises 6.8-7.6 wt. % Al, 0.8-1.6 wt. % Mo, 1.6-2.4 wt. % Nb, 0.15-0.45 Sn, 0.1-0.3 wt. % Zr, 0.1-0.3 wt. % Si, 0.1-0.2 wt. % O, with the remainder being Ti and incidental impurities.

9. The method according to claim 1, wherein the alpha-beta product composition comprises 5.7-6.7 wt. % Al, 1.7-2.3 wt. % Mo, 1.8-2.4 wt. % Nb, 2.4-3.2 Sn, 1.8-2.6 wt. % Zr, 0.1-0.3 wt. % Si, 0.1-0.2 wt. % O, with the remainder being Ti and incidental impurities.

10. An alpha-beta titanium alloy comprising:
a composition in weight percent (wt. %) comprising 5.7-7.5 wt. % Al, 0.8-4.2 wt. % Mo, 0.0-3.0 wt. % Nb, 0.1-3.5 Sn, 0.1-3.0 wt. % Zr, 0.1-0.35 wt. % Si, 0.05-0.25 wt. % O, with a remainder being Ti and incidental impurities;
an acicular microstructure comprising needles of alpha in a matrix of beta; and
an EN 6072 testing fatigue life of more than 1.0E+07 cycles.

11. The alpha-beta titanium alloy according to claim 10 further comprising a time to 0.25% strain at 35 ksi and 950° F. (510° C.) for the heat treated alpha-beta product is greater than 50 hours.

12. The alpha-beta titanium alloy according to claim 11, wherein the time to 0.25% strain at 35 ksi and 950° F. (510° C.) for the heat treated alpha-beta product is greater than 75 hours.

13. The alpha-beta titanium alloy according to claim 12, wherein the time to 0.25% strain at 35 ksi and 950° F. (510° C.) for the heat treated alpha-beta product is greater than 100 hours.

14. The alpha-beta titanium alloy according to claim 10, wherein the composition comprises 6.4-7.4 wt. % Al, 2.1-2.6 wt. % Mo, 0.5-1.5 wt. % Nb, 1.0-1.8 Sn, 0.5-1.5 wt. % Zr, 0.1-0.3 wt. % Si, 0.1-0.15 wt. % O, with the remainder being Ti and incidental impurities.

15. The alpha-beta titanium alloy according to claim 14 further comprising a tensile strength greater than about 153 ksi, a yield strength greater than about 130 ksi, a percent elongation greater than about 3%, and an elastic modulus greater than about 17.5 Msi at 75° F. (23.9° C.).

16. The alpha-beta titanium alloy according to claim 14 further comprising a tensile strength greater than about 90 ksi, a yield strength greater than about 68 ksi, a percent elongation greater than about 15%, and an elastic modulus greater than about 13.0 Msi at 1150° F. (621.1° C.).

17. The alpha-beta titanium alloy according to claim 10, wherein the composition comprises 6.8-7.6 wt. % Al, 0.8-1.6 wt. % Mo, 1.6-2.4 wt. % Nb, 0.15-0.45 Sn, 0.1-0.3 wt. % Zr, 0.1-0.3 wt. % Si, 0.1-0.2 wt. % O, with the remainder being Ti and incidental impurities.

18. The alpha-beta titanium alloy according to claim 19 further comprising an elastic modulus greater than about 10.0 Msi at 1150° F. (621.1° C.).

19. The alpha-beta titanium alloy according to claim 10, wherein the composition comprises 5.7-6.7 wt. % Al, 1.7-2.3 wt. % Mo, 1.8-2.4 wt. % Nb, 2.4-3.2 Sn, 1.8-2.6 wt. % Zr, 0.1-0.3 wt. % Si, 0.1-0.2 wt. % O, with the remainder being Ti and incidental impurities.

20. The alpha-beta titanium alloy according to claim 19 further comprising a tensile strength greater than about 155 ksi, a percent elongation greater than about 3%, and an elastic modulus greater than about 17.0 Msi at 75° F. (23.9° C.).

21. The alpha-beta titanium alloy according to claim 19 further comprising a tensile strength greater than about 95 ksi, a yield strength greater than about 73 ksi, a percent elongation greater than about 16%, and an elastic modulus greater than about 12.0 Msi at 1150° F. (621.1° C.).
